(19) United States
(12) Patent Application Publication
(10) Pub. No.: US 2006/0050661 A1
(43) Pub. Date: Mar. 9, 2006

(54) Method for conducting link adaptation without collision in wireless network

(75) Inventors: Seung-seop Shim, Anyang-si (KR); Chang-yeul Kwon, Seongnam-si (KR); Ho-seok Lee, Suwon-si (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD.

(21) Appl. No.: 11/220,601

(22) Filed: Sep. 8, 2005

(30) Foreign Application Priority Data
Sep. 8, 2004 (KR) 10-2004-0071750

(51) Int. Cl. H04L 12/26

(52) U.S. Cl. 370/318; 370/332

(57) ABSTRACT

A method for conducting link adaptation without collision in wireless network, includes setting, by a first device constituting a first wireless network, information regarding the power level required for transmitting data from the first wireless network, a priority level, and a notice of link adaptation in a first frame, sending the set first frame wirelessly, receiving a second frame including a response to the sent first frame from a second device constituting a second wireless network having received the first frame, and sending data at the power level that is detailed in the second frame when transmission of data with the power level is permitted.

### CROSS-REFERENCE TO RELATED APPLICATION

This application claims priority from Korean Patent Application No. 10-2004-0071750 filed on Sep. 8, 2004 in the Korean Intellectual Property Office, the disclosure of which is incorporated herein by reference in its entirety.

### BACKGROUND OF THE INVENTION

1. Field of the Invention

Methods consistent with the present invention are directed to link adaptation without collision in a wireless network.

2. Description of the Related Art

Recently, there is an increasing demand for ultra high-speed communication networks due to widespread public use of the Internet and a rapid increase in the amount of available multimedia data. Since local area networks (LANs) emerged in the late 1980s, the data transmission rate over the Internet has drastically increased from about 1 Mbps to about 100 Mbps. High-speed Ethernet transmission is now popular and widespread. Currently, intensive research into gigabit speed Ethernet is under way. An increasing interest in wireless networks and communication has triggered the research and development of wireless local area networks (WLANs), which has greatly increased the availability of the WLANs to consumers. Although WLANs have a lower transmission rate and are not as stable as wired LANs, WLANs have various advantages, including wireless networking capability, greater mobility and so on. Accordingly, WLAN markets have been gradually growing.

Due to the need for a greater transmission rate and the development of wireless transmission technology, the initial IEEE 802.11 standard, which specifies a 1 to 2 Mbps transmission rate, has evolved into advanced standards such as IEEE 802.11b and IEEE 802.11a. Currently, the new IEEE standard, 802.11g, is being discussed by the Standardization Conference groups. The IEEE 802.11g standard, which delivers a 6 to 54 Mbps transmission rate in the 56 GHz-National Information Infrastructure (NII) band, uses the orthogonal frequency division multiplexing (OFDM) transmission technology. With an increasing public interest in OFDM and use of the 5 GHz band, much greater attention has been paid to OFDM than other wireless standards.

Recently, a wireless Internet service called “Nespot” that uses a WLAN has been launched by Korea Telecommunication (KT) Corporation, Korea. Nespot services allow access to the Internet using a WLAN according to IEEE 802.11b, commonly called Wi-Fi (wireless fidelity). Communication standards for wireless data communication systems, which have been completed and promulgated, or are being researched and discussed, include Wide Code Division Multiple Access (WCDMA), IEEE 802.11x, Bluetooth, IEEE 802.15.3, and others, which are known as 3rd Generation (3G) communication standards. The most widely known and cheapest wireless data communication standard is IEEE 802.11b, which is part of the IEEE 802.11x series. An IEEE 802.11b WLAN standard delivers data transmission at a maximum rate of 11 Mbps and utilizes the 2.4 GHz Industrial, Scientific, and Medical (ISM) band, which can be used below a predetermined power without permission. With the recent widespread use of the IEEE 802.11a WLAN standard, which delivers a maximum data rate of 54 Mbps in the 5 GHz band by using OFDM, IEEE 802.11g, which was developed as an extension to the IEEE 802.11a for data transmission in the 2.4 GHz band using OFDM, is intensively being researched.

Ethernets and WLANs, which are currently being widely used, utilize a carrier sensing multiple access (CSMA) method. According to the CSMA method, it is determined whether a channel is in use, and if the channel is not in use, that is, if the channel is idle, then data is transmitted. If the channel is busy, re-transmission of data is attempted after a predetermined period of time. A carrier sensing multiple access with collision detection (CSMA/CD) method, which is an improvement of the CSMA method, is used in a wired LAN, whereas a carrier sensing multiple access with collision avoidance (CSMA/CA) method is used in packet-based wireless data communications. In the CSMA/CD method, a station suspends transmitting signals if a collision is detected during transmission. In the CSMA method, it is pre-checked whether a channel is busy before transmitting data. On the other hand, in the CSMA/CD method, a station detects signal collision in a channel. In the CSMA/CD method, the station suspends transmission of signals when a collision is detected and transmits a jam signal to another station to inform it of the collision. After transmitting the jam signal, the station waits a random backoff period and re-transmits the signals. In the CSMA/CD method, the station does not immediately transmit data even after the channel becomes idle but waits a random backoff period (a predetermined period of time) before re-transmitting, in order to avoid signal collision. When signal collision occurs during transmission, the random backoff period is doubled, thereby further lowering the probability of collision.

FIG. 1 is a diagram illustrating the setting of an NAV value in order to avoid a collision according to the conventional art. Referring to FIG. 1, a sending station 10 sends a Request To Send (RTS) frame before sending data, and a receiving station 11 and another station 12 can both recognize it. The receiving station 11 then sends a Clear To Send (CTS) frame, and the station 12 sets a network allocation vector (NAV) (virtual carrier sensing). Other stations do not send data until the NAV value becomes 0, and they may set an NAV value again in response to the CTS frame sent by the receiving station 11. Even though the RTS frame is not received, an NAV value can be set again based on the received CTS frame. Thereafter, until the sending station sends data to the receiving station, other stations do not use the channel. To send a frame to another station, the station 12 may wait a distributed inter-frame space (DIFS) after the NAV period elapses, and send the frame to the other station after a random backoff period.

If carrier sensing is implemented in the medium, during the random backoff period the station suspends the random backoff period and waits until the channel is idle. When the channel is idle, the station waits a DIFS again and resumes the random backoff period.

This random backoff period implies time consumed until a sending station receives an acknowledgement (ACK) frame from a receiving station to acknowledge receipt of a frame sent by the sending station. The receiving station sends an ACK frame to the sending station after a short inter-frame space (SIFS) has elapsed since it received the frame. Based on information regarding duration, a station in wireless network sets an NAV (virtual carrier sensing). The station waits a DIFS and a random backoff period after the NAV period has elapsed, and then sends a frame to another station. If the station detects carrier sensing in the medium during the random backoff period, it suspends the random backoff, and waits for when the channel is idle. When the channel is idle, the station waits a DIFS and implements the random backoff.

FIG. 1 illustrates the process of virtual carrier sensing. However, collisions cannot be avoided in virtual carrier sensing. Especially, where several wireless networks coexist, a method for avoiding interference and collisions is required. A new technique called “link adaptation” (LA) has recently been proposed, whereby more efficient transmission may be available by reflecting the state of a wireless channel in data transmissions. This is designed to reduce an error in transmission by increasing or decreasing the transmission rate or power according to the state of a channel. For example, by determining a transmission rate (Tx rate) and power of PHY.TXSTART.req (TXVECTOR) in a sender's physical layer, and considering the state of the current channel using the received signal strength indication (RSSI) of PHY.RXSTART.req (RXVECTOR) received from a receiver's physical layer under 802.11, a sending station may increase or decrease the transmission rate and power.

However, this link adaptation has the following problem. When each network covering a communication area or an access point (AP) independently attempts to conduct a link adaptation, or a station's power is turned on, thereby invading the communication area of another network, the quality of communication between the two networks is degraded, and thus, the two networks suspend communication, and thereafter resume communication. This problem will be described in detail with reference to FIG. 2.

FIG. 2 schematically depicts a problem that occurs in link adaptation according to the conventional art.

An AP A 101 and a station (STA) A1 201 belonging to a network A having the communication area A may extend the communication area to an area A′ by use of an LA mechanism because the communication quality has degraded. In this case, the area A′ reaches an STA B1 211 belonging to a network B, and the STA B1 211 experiences degraded communication quality and the extended network A also suffers from the degraded communication quality because of a collision with the STA B1 211. As a result, through a link adaptation to increase transmission power, the communication area of the network A may be extended again to an area A″. In this case, as the communication area of the network A substantially overlaps the communication area of network B covering an AP B 102, communications between the two networks is suspended because of the degraded communication quality, and they try to resume communications thereafter. When network B reduces the communication area through a link adaptation, an STA B2 212, which was veiled for a while during the previous communications but is now unveiled, may increase transmission power to locate network B. Alternatively, in the case of an ad-hoc or highly mobile network, communications may be suspended because of the overlapped communication area.

Accordingly, there is a need for a method to prevent overlapping in a communication area and suspension in communications generated because a network unilaterally conducts link adaptation without considering the other network's state.

### SUMMARY OF THE INVENTION

An aspect of the present invention is to coordinate transmission power required for data transmission under cooperation with another network.

Another aspect of the present invention is not to invade a communication area of any adjacent network by coordinating the transmission power.

The present invention is directed to link adaptation to remove collision in a wireless network.

According to an aspect of the present invention, there is provided a method for conducting a link adaptation without collision in a wireless network, comprises setting, by a first device constituting a first wireless network, information regarding the power level required for transmitting data from the first wireless network, a priority level, and a notice of link adaptation in a first frame, sending the set first frame wirelessly, receiving a second frame including a response to the sent first frame from a second device constituting a second wireless network having received the first frame, and sending data at the power level that is detailed in the second frame when transmission of data with the power is permitted.

According to another aspect of the present invention, there is provided a method of conducting a link adaptation without collision in a wireless network, comprises receiving, by a device constituting a second wireless network, a first frame to notify of link adaptation from a device constituting a first wireless network, extracting information regarding a priority level involved in data transmission in the first wireless network, from the received first frame, and sending a second frame to allow the link adaptation by the first wireless network when the priority level is higher than that of the second wireless network.

### BRIEF DESCRIPTION OF THE DRAWINGS

The above and other aspects of the present invention will become more apparent by describing in detail exemplary embodiments thereof with reference to the attached drawings in which:

FIG. 1 is a diagram illustrating setting an NAV value to avoid a collision according to a conventional art;

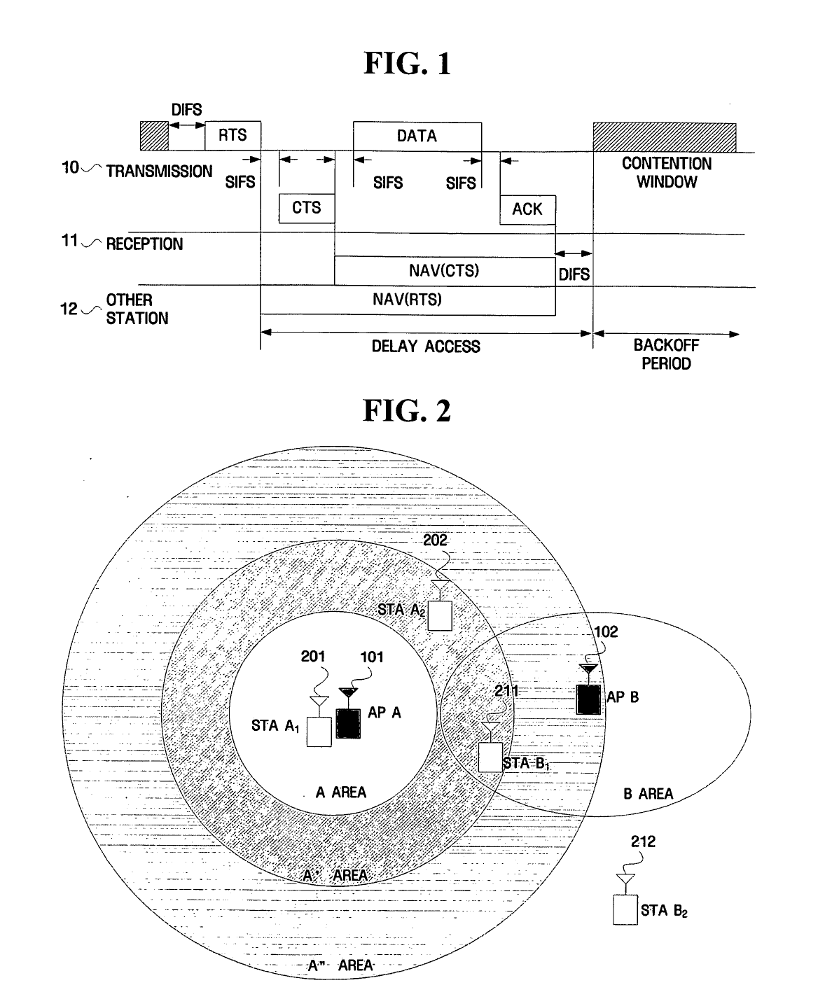

FIG. 2 schematically depicts a problem caused in a link adaptation according to a conventional art;

FIG. 3 is a flowchart illustrating a process whereby a device to manage a wireless network gives another network a previous notice that transmission power will be coordinated, according to an exemplary embodiment of the present invention;

FIG. 4 is a flowchart illustrating a process of receiving a frame to previously notify coordination of transmission power sent to another network by a device to manage a wireless network, according to an exemplary embodiment of the present invention;

FIG. 5 is a flowchart illustrating a process of sending and receiving a frame including a link adaptation between a sender side and a receiver side, according to an exemplary embodiment of the present invention;

FIGS. 6A and 6B illustrate structures of frames according to exemplary embodiments of the present invention;

FIGS. 7A and 7B are tables illustrating examples of vector parameters according to an exemplary embodiment of the present invention;

FIG. 8 is a table illustrating priority levels according to an exemplary embodiment of the present invention;

FIG. 9 is a view illustrating how the sending procedure is changed in a conventional method according to an exemplary embodiment of the present invention;

FIG. 10 is a view illustrating how the receiving procedure is changed in a conventional method according to an exemplary embodiment of the present invention; and

FIGS. 11A and 11B illustrate constructions of primitives of a MLME part of an MAC layer when a receiver side permits or does not permit a sending side to conduct link adaptation, according to an exemplary embodiment of the present invention.

### DETAILED DESCRIPTION OF THE INVENTION

The following terms used throughout this specification will be described in brief.

Priority Level, Urgent Level

A priority level is a criterion to indicate the degree of urgency of the wireless transmission/reception of data. When continuous transmission without suspension or interruption is requested, or when a plurality of devices coexist in a network, a higher priority may be set. A priority may be set in various manners. In this specification, a priority is allocated according to the property of data to be sent, but this is merely exemplary.

BSS

BSS stands for “basic service set,” which is a fundamental element of a wireless network. BSS is a set of stations logically connected to each other.

IBSS

IBSS stands for “independent basis service set,” which refers to a set of stations in an ad-hoc network which use no access point. This network features temporary and short-term connection between nodes.

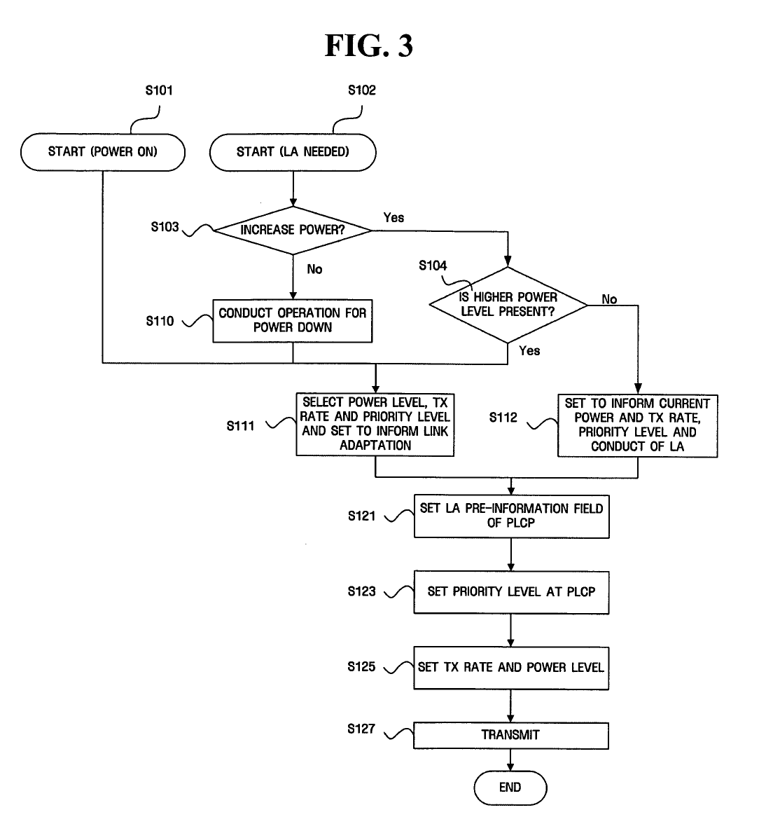

Recently, devices of a wireless network employ an LA algorithm to change the transmission rate (Tx rate) or transmission power or to enhance the quality of communication if it is degraded. However, this change of transmission power may extend the communication area of the network, and this extension may disturb the communications of other networks adjacent thereto, as described with reference to FIG. 2.

Accordingly, there is in need of a method to change or maintain the transmission power through coordination with other networks, rather than unilaterally changing the transmission power.

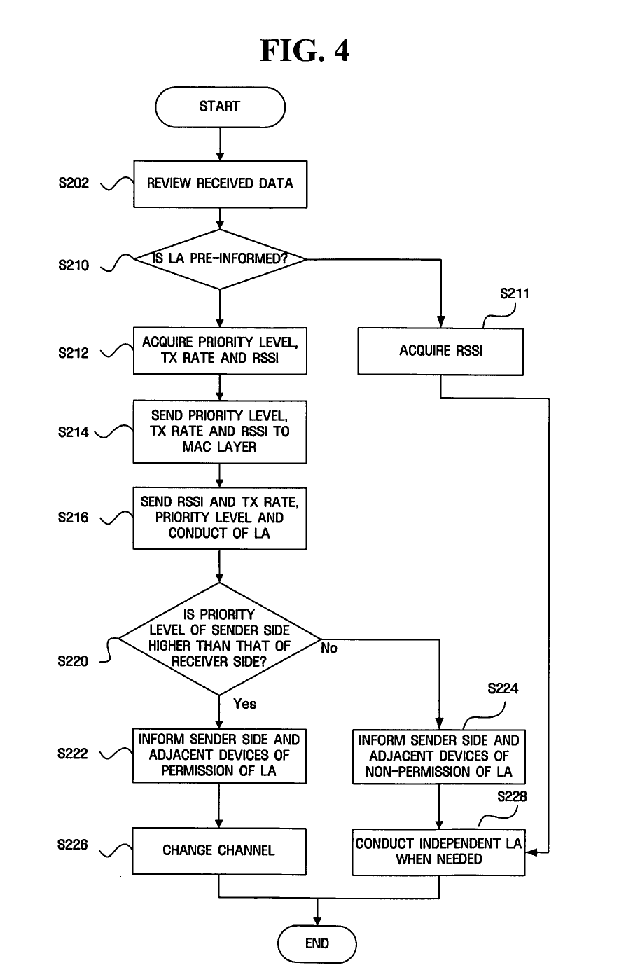

FIG. 3 is a flowchart illustrating an operation whereby a device to manage a wireless network gives another network a previous notice that transmission power will be coordinated according to an exemplary embodiment of the present invention.

As an exemplary embodiment of the present invention, a process to conduct link adaptation in a wireless network using one of the IEEE 802.11 protocols is illustrated in FIG. 3. Roughly, there are two operations; one is conducted in a medium access control (MAC) layer in association with a setup and the other is conducted in transferring the set up operation to a physical layer. Operations S101 to S112 are MAC layer operations and operations S121 to S121 are physical layer operations.

Transmission power is adjusted when a wireless network managing device turns on the power of a specified station in operation S101, or when link adaptation is conducted because the communication quality of the wireless network managing device has changed. When power is turned on, since a power level and a transmission rate, both of which are currently set, are not present, the process proceeds to operation S111 to set a new value.

Next, operation S102 for link adaptation will be considered. LA is conducted to increase or decrease transmission power in operation S103. In the case of decreasing the power, a transmission power is chosen that does not to degrade the quality of internal communication in operation S110. The power can be lowered by one or several levels by a predetermined algorithm. A target transmission power level, a priority level and a notice to inform of execution of link adaptation are set in operation S111.

In operation S104, it is determined whether a power level higher than the current transmission power level is present. When a power level higher than the current transmission power level is present, the process proceeds to operation S111 where the transmission power is set to a higher level. When a higher power level is not present, the transmission power is set to the current power level in order to coordinate with other networks, and a transmission rate, a priority level and a notice to inform of execution of link adaptation in compliance with the set current power level are set in operation S112.

To transmit information set in the MAC layer through the physical layer, an operation to set a frame or a signal portion is needed. In the network device, the physical layer receives a signal sent and received in a wireless manner, but it cannot send the signal upward to the MAC layer if the signal does not carry data targeted for it. In addition, depending upon method of implementation, the physical layer may send the signal upward to the MAC layer so that the MAC layer can acquire data targeted for the MAC layer or the whole layers. Accordingly, when data is sent to another network area, for example, it is received in a network area other than the target network area, the physical layer may not send it upward to the MAC layer; it may also be sent upward to the MAC layer so that the MAC layer can determine that, based on the designation address, the address is targeted for the MAC layer, or for the whole layers. In this specification, since an operation to send data to another network area for link adaptation is necessary, a pre-informed link adaptation field to send data upward to the MAC layer from the physical layer is included, thereby coping with both cases.

In operation S121, the pre-informed LA field is set, the physical layer of a receiver side reviews the set value, and sends corresponding information to the MAC layer when the pre-informed link adaptation field has been set.

In operation S123, the priority level is set, and the transmission rate and power are set in operation S125. A frame set in this way is sent in operation S127.

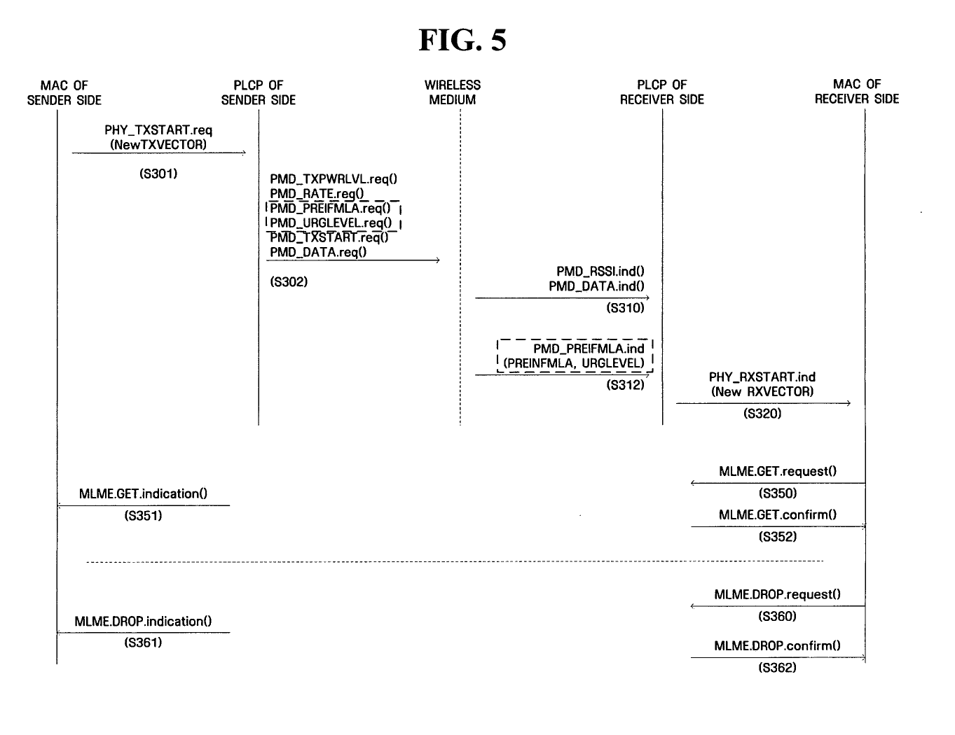

FIG. 4 is a flowchart illustration of a process of receiving a frame to pre-inform about a change in the transmission power, which is transmitted to a different network by the wireless network managing device.

Referring to FIG. 4, a network managing device, which received a signal including a frame set in FIG. 3, analyzes this signal, determines whether to accept or reject a link adaptation in response to the pre-informed link adaptation, and sends the determination to the sender side. According to the determination, the sender side can change the channel or independently conduct link adaptation.

The sender side reviews data from the received signal in operation S202. In operation S210, when a pre-informed link adaptation field is not set, only a value of a the received signal strength indication (RSSI) is acquired in operation S211. With this value, the link adaptation can be independently conducted later when necessary in operation S228. When the pre-informed link adaptation field of the receiving data is set in operation S210, this information should be sent to the MAC layer. Thus, a priority level, a transmission rate, and RSSI is acquired from the received data in operation S212, and the acquired information is sent to the MAC layer in operation S214.

The MAC layer obtains the RSSI, transmission rate, priority level and power level from the received information in operation S216 and compares the priority level of the sender side with its own priority level in operation S220. When the priority level of the sender side is higher, the MAC layer informs the sender side and neighboring network devices that the sender side is permitted to conduct link adaptation to change the power level in operation S222. When the sender side changes the power level, the receiver side instructs the devices constituting its own network change the channel to thereby avoid overlapped communication areas.

Since the channel is changed in operation S226, no collision occurs even if the sender side changes the transmission power level. In addition, when it is highly likely that a collision may be generated while the current power level is maintained, the sender side can send data to coordinate with other network areas. Since there is no transmission power level to further increase or there still remains a possibility that a collision may occur even though the transmission power level is lowered in FIG. 3, so operations S110 and S112 of FIG. 3 need to be executed to pre-inform a link adaptation.

When the priority level of the sender side is lower than that of the MAC layer, the receiver side informs the sender side and neighboring network devices that link adaptation is not permitted in operation S224. Later, an independent link adaptation may be conducted by the receiver side in operation S228.

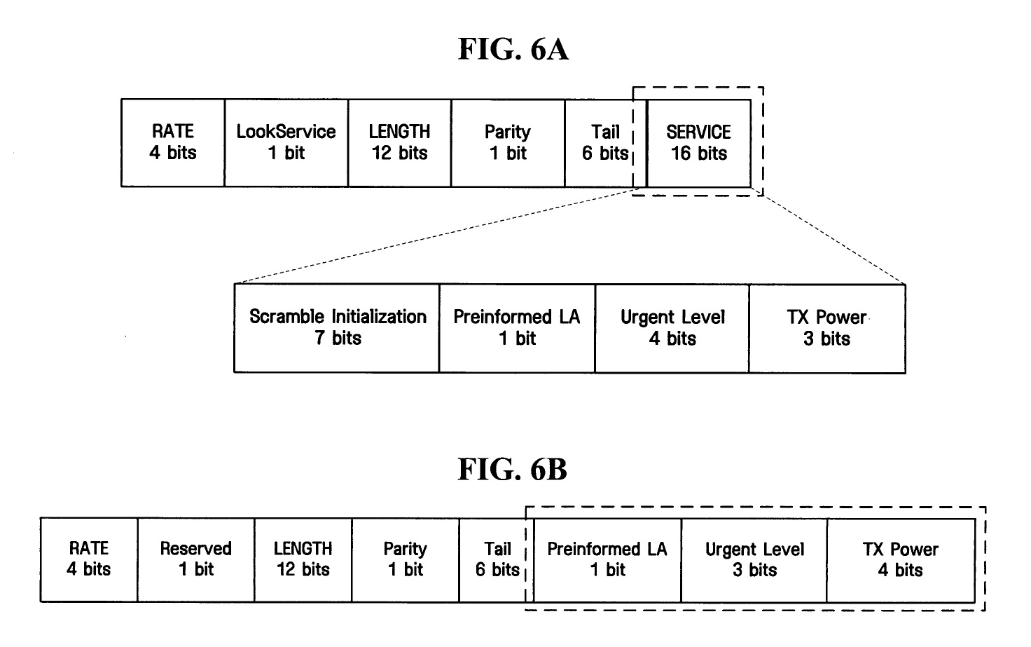

FIG. 5 is a flowchart illustrating a process of sending and receiving a frame including a link adaptation, between a sender side and a receiver side, according to an exemplary embodiment of the present invention. An MAC layer of the sender side uses PHY_TXSTART.req( ) to send data to a physical layer convergence procedure (PLCP). This primitive has a vector NewVECTOR as a parameter. This vector informs of link adaptation, and includes data to change the power level and the priority level.

The PLCP layer will be described in brief in the following. To use a radio wave with a physical layer, a relatively complex physical (PHY) layer is needed. Accordingly, the physical layer under IEEE 802.11a is divided into a PLCP layer and a physical medium dependent (PMD) system. The PLCP layer constitutes a upper portion of the physical layer in the 802.11a network, and it transforms a frame of the MAC layer. Each physical layer has its own PLCP layer to provide an auxiliary frame to the MAC layer. The PMD layer is responsible for sending a radio frequency (RF) signal to another station in order to send the above-described frame.

When PHY_TXSTART.req( ) is sent to the PLCP layer from the MAC layer, data is sent to the PMD layer from the PLCP layer, using values constituting the vector NewTXVECTOR (S301). They are separated into PMD_TXPWRLVL.req( ), PMD-RATE.req( ), PMD_PREIFMLA.req( ), PMD_URGLEVEL.req( ), PMD_TXSTART.req( ), and PMD_DATA.req( ), and are then sent (S302). Here, the portions of PMD_PREIFMLA.req( ) and PMD_URGLEVEL.req( ) are required for informing of link adaptation. When the PMD layer that received them converts them into signals and sends them to the receiver side, the PMD layer of the receiver side converts them again into data. As a result, the PMD layer of the receiver side sends PMD_RSSI.ind( ), PMD_DATA.ind( ), PMD_PREIFMLA.ind (PREINFMLA, URGLEVEL) to the PLCP layer (S310 and S312). Here, PMD_PREIFMLA.ind (PREINFMLA, URGLEVEL) is used to send information required to inform the PLCP layer of link adaptation. Having received this, the PLCP layer sends data to inform the MAC layer of link adaptation. This operation is conducted through PHY_RXSTART.ind(NewVECTOR) (S320).

Through operations (S301 to S320) (described above), the receiver side, knowing that the sender side informed of link adaptation, determines whether to permit the link adaptation, based on the data sent from the sender side. The determination may be made based on the priority level described above. When the receiver side desires to permit the link adaptation, the receiver side sends a signal to inform of the permission and changes the channel so as to allow link adaptation to be conducted without collisions. The receiver side sends MLAME.GET.request( ) to the PLCP layer in order to inform the sender side of the permission, which is then sent to the MAC layer of the sender side (S350). The sender side informs of whether the link adaptation has been conducted through MLME.GET.indication( ) (S351). And the receiver side informs the MAC layer of the sender side that the signal has been properly been transmitted through MLME.GET.confirm( ) from the PLCP layer (S352). Thereafter, the receiver side can conduct operations to avoid collisions by changing the channel or transmission power.

On the other hand, if the priority level of the sender side is lower than that of the receiver side, a link adaptation by the sender side may not be permitted. In this case, similar operations are conducted as if the link adaptation was permitted. The receiver side sends MLME.DROP.request( ) to the PLCP layer to inform that the link adaptation is not permitted. MLME.DROP.request( ) is sent via the wireless medium to the MAC layer of the sender side (S360). Therefore, the sender side can know based on MLME.DROP.indication( ) that the link adaptation will not be conducted (S361). In the meantime, the receiver side again informs the MAC layer of the sender side that the signal has been properly transmitted from the PLCP layer through MLME.DROP.confirm( ) (S362). An operation to perform an independent link adaptation thereafter has been described with respect to FIG. 4.

According to exemplary embodiments described above, overlapping with power transmitted from another network can be avoided. Thus, degradation in the communication quality is avoided by mutual adaptation, thereby avoiding collisions.

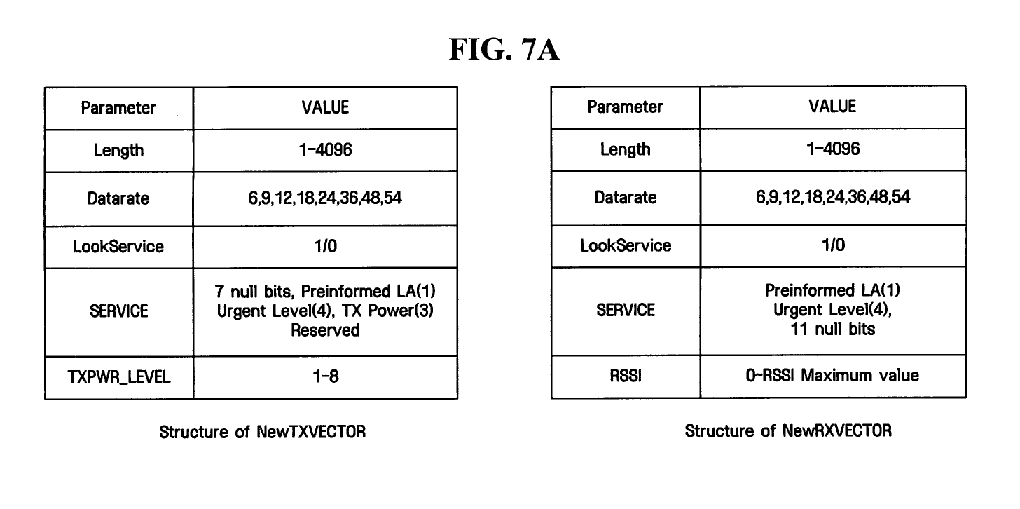

FIGS. 6A and 6B illustrate structures of frames according to exemplary embodiments of the present invention.

FIG. 6A is directed to storage of information in a service field. Under IEEE 802.11, information to inform of link adaptation may be stored in the service field (SERVICE). Also, by using an existing reserved bit (Reserved Bit) as a service reference field (LookService) to indicate that information regarding link adaptation is stored in the service field, when the service referenced field is set to 1, this indicates that the link adaptation information is stored in the service field.

FIG. 6B is directed to definition of a field for an independent signal to transmit and receive data. Frames illustrated in FIGS. 6A and 6B include bits for pre-informing of link adaptation (Preinformed LA), and notifying of the level of urgency (Urgent Level), and of the transmission power (TX Power).

With the frame configuration illustrated in FIGS. 6A and 6B, information to adjust the power level of the devices of different networks can be sent and received. Although the sender side sends a signal in either the broadcast or unicast mode, a physical layer of a communication device in another network can receive the signal if the communication areas of the two networks overlap. If the signal received by the physical layer is not targeted for itself, it is not sent to the MAC layer or otherwise sent to the MAC layer so as to determine whether it is targeted for itself, after receiving signal. As described above with respect to FIG. 6A and FIG. 6B in the first case, e.g., when a field to inform of link adaptation (from data received by the physical layer) is set, even though the signal received by the physical layer is not targeted for it, this data may be sent to the MAC layer. As a result, if the physical layer can interpret information transmitted and received from a different network because channels of the networks are identical or their communication areas overlap, this implies that a collision may be generated when the power is increased. In this case, data for link adaptation may be exchanged. Also, since the link adaptation is conducted under mutual cooperation, the phenomenon of communication areas overlapping disappears when one network changes the transmission channel or power, thereby enhancing the communication quality.

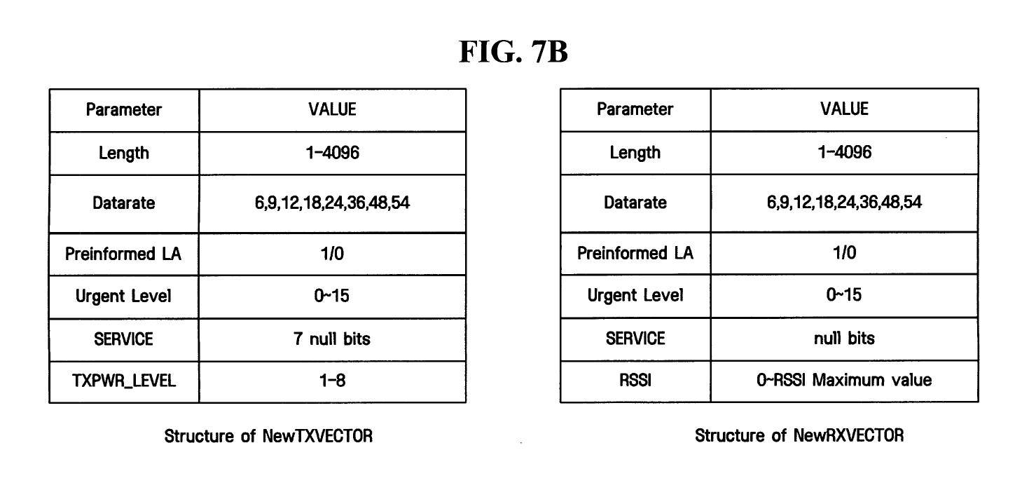

FIGS. 7A and 7B are tables illustrating examples of vector parameters according to an exemplary embodiment of the present invention. FIG. 7A shows vector parameters required for transmission and reception of frames as described in FIG. 6A. NewTXVECTOR includes parameters required for when an MAC layer of the sender side sends data to a PLCP layer. First, a length field (Length) has information regarding the length of a frame. A transmission rate field (Datarate) determines the speed of sending data. In FIG. 7A, a reserved bit of a frame is used as a service reference field (LookService). When the value of this field is 0 or 1 (defined in advance), the physical layer searches for a service field of this frame, and when a pre-informed link adaptation bit of this service field is set to value which was defined in advance, the physical layer sends an operation to permit the link adaptation to the MAC layer so that the MAC layer can conduct the operation. TXPWR_LEVEL represents the transmission power level.

FIG. 7B shows respective constructions of NewTXVECTOR and NewRXVECTOR when a frame is sent and received in the same manner as the frame of FIG. 6B.

A length field (Length), a data transmission rate field (Datarate), a level of transmission power field (TXPWR_LEVEL), and RSSI are identical to those of FIG. 7A. FIG. 7B is concerned with the independent formation of fields. A pre-information link adaptation field (Preinformed LA) to inform of link adaptation and a priority level field (Urgent Level) exist as independent parameters in NewTXVECTOR and NewRXVECTOR.

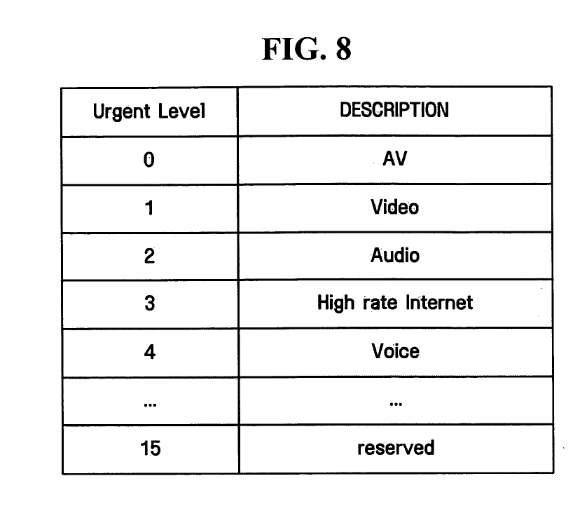

FIG. 8 is a table showing urgent levels according to an exemplary embodiment of the present invention. The urgent levels may be set in various manners. In transmitting data, data to be sent preferentially is determined based on the importance of the data, or on the requirement that the data be sent without interruption or suspension. They may also be determined based on the number of the devices belonging to a single network. The urgent levels of FIG. 8 are determined based on the requirement that the data be sent without interruption. When image and sound data are sent together, for example, when moving images such as a movies are interrupted or suspended, the communication quality is greatly degraded, and thus, they are given the highest urgency level. Then, video, audio, high speed internet and voice data sequentially follow in terms of urgency level. However, the urgency levels may differ with different examples.

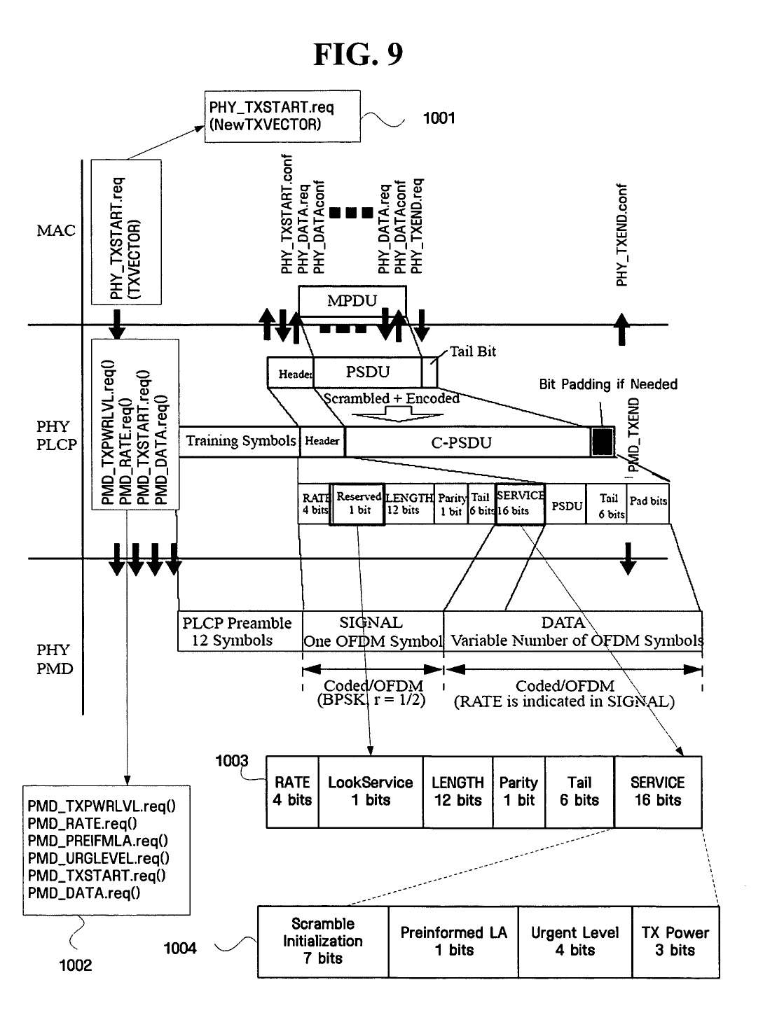

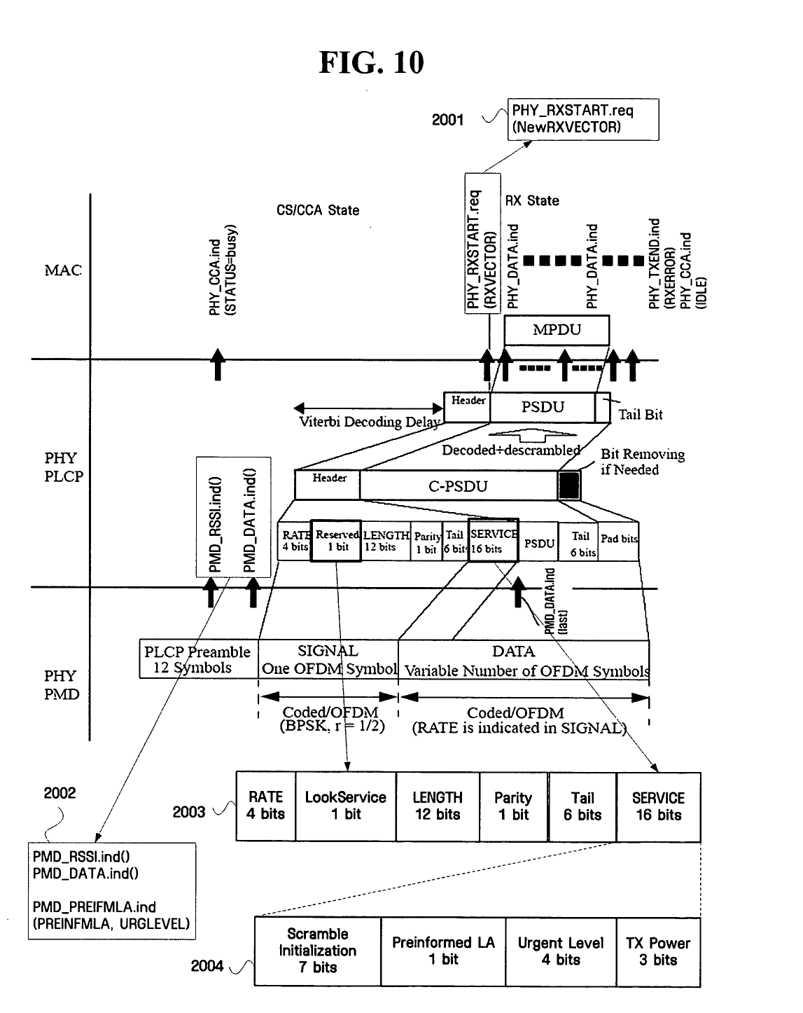

FIGS. 9 and 10 show how conventional transmission and reception procedures change in IEEE 802.11. FIGS. 9 and 10 illustrate exemplary embodiments of the present invention, whose details may change when using another wireless protocol.

FIG. 9 illustrates how a sending procedure according to an example of the present invention differs from the conventional method.

PHY_TXSTART.req( ) to send data from an MAC layer to a PLCP layer takes the value of NewTXVECTOR 1001 described above as a parameter. The PLCP layer having received this value sends data to the PMD layer by adding functions of PMD_PREIFMLA.req( ) and PMD_URGLEVEL.req( ) thereto. On the other hand, data to be sent includes a reserved bit as a service reference bit (Look Service), and a service field (SERVICE) includes data for link adaptation (1003 and 1004). The sending procedure of FIG. 9 sends a frame in FIG. 6A, which may be changed when frames according to FIG. 6B or other examples are sent.

FIG. 10 illustrates how a receiving procedure according to an example of the present invention differs from a conventional method. The frame included in the signal received through the PMD layer refers to the frame of FIG. 6A (2003 and 2004). To send information constituting this frame to the PLCP layer from the PMD layer, a function PMD_PREINMFLA.ind(PREINFMLA, URGLEVEL) of operation S112 of FIG. 5 should be used (2002). The PLCP layer having received the information produces NewRXVECTOR defined in FIG. 7, and sends it to the MAC layer by use of PHY_RXSTART.req(NewRXVECTOR).

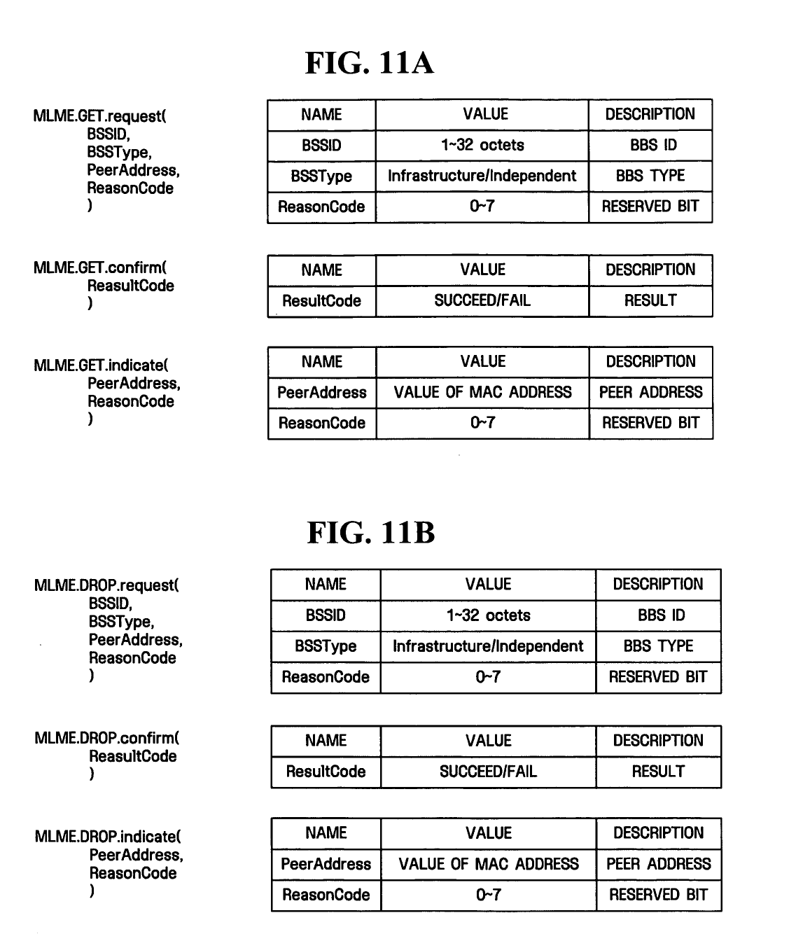

FIGS. 11A and 11B illustrate an exemplary construction of primitives of an MAC layer MLME part when the receiver side allows or does not allow the sender side to conduct link adaptation.

FIGS. 11A and 11B illustrate the MLME entities transmitted and received in FIG. 5. An MAC layer management entity (MLME) is an entity with which the MAC layer exchanges information; specifically, with the physical layer. FIG. 11A illustrates constructions of MLME primitives that are exchanged when link adaptation is permitted. When link adaptation is permitted, the MAC layer of the receiver side uses MLME.GET.request( ). As parameters to constitute it, there are present, BSS identifier (BSSID) and BSS type (BSSType) parameters, an MAC address of the receiver side (PeerAddress), and a reserved for future use bit to explain a reason for future use, for example, “GET”.

The following cases require the BSS identifier and the BSS type of the receiver side. When link adaptation is pre-informed, two or more BSSs may be present that use the same channel on the receiver side. Thus, it should be known which BSS will grant permission. In this case, permission or non-permission can be identified according to each BSS. As an example, when a BSS grants permission but the other BSS does not, this implies non-permission. Accordingly, the sender side that requested the link adaptation should change channels. Also, the BSS that gives up a channel previously permitted also changes channels. Channel change can be channel movements.

When the same channel is used as in the above embodiment, the BSS type is needed. The channel is operated with different BSS types because of different communication areas. When the channel has the same BSS identifier, one party may inform permission as a BSS and the other party may inform permission as an IBSS. In this case, if they are not differentiated, it cannot be known which BSS has granted the permission because both BSSs have the same BSS identifier.

The MLME is transmitted to the sender side through a wireless medium. The sender side can know through MLME.GET.indication( ) whether a link adaptation has been conducted and what the result of that conduct is based on information regarding the MLME.GET.request( ) sent to the sender side. In addition, the receiver side can know whether link adaptation permission has been sent to the sender side through a result code (ResultCode) of MLME.GET.confirm( ), and may conduct operations to change the channel, retain the current channel or decrease the transmission power based on the result.

FIG. 11B illustrates the construction of parameters when a link adaptation is not permitted. The construction and meanings of parameters in FIG. 11B are identical to those described with respect to FIG. 11A, and thus, descriptions thereof will be omitted.

According to the present invention, the channel and the transmission power can be adjusted in cooperation with other networks without manipulation by a user.

In addition, transmission power can be adjusted without invading the communication area of another network.

While the present invention has been particularly shown and described with reference to exemplary embodiments thereof, it will be understood by those skilled in the art that various variations, modifications or changes in the form and details may be made therein without departing from the spirit and scope of the invention as defined by the appended claims. The exemplary embodiments should be considered in a descriptive sense only and are not for purposes of limitation. Therefore, the scope of the invention is defined not by the detailed description of the invention but by the appended claims, and all differences within the scope will be construed as being included in the present invention.

What is claimed is:

1. A method for conducting a link adaptation without collision in a wireless network, the method comprising:
setting a first frame, by a first device of a first wireless network, by setting information regarding a power level required for transmitting data from the first wireless network, a priority level, and a notice of link adaptation in the first frame;
sending the first frame wirelessly;
receiving a second frame including a response to the first frame from a second device of a second wireless network having received the first frame; and
sending data at a power level that is specified in the second frame if transmission of data with the power level specified in the second frame is permitted.

2. The method of claim 1, wherein the first and second wireless networks are based on IEEE 802.11 or IEEE 802.15.

3. The method of claim 1, wherein the priority level information represents a kind of data sent and received within the first wireless network.

4. The method of claim 1, wherein the priority level information represents a higher necessity for transmission without interruption when transmitting data within the first wireless network.

5. The method of claim 1, wherein the setting the first frame comprises setting a reserved bit of the first frame with a value agreed upon in advance, and setting information regarding the power level required for transmitting data from the first wireless network, the priority level and the notice of link adaptation in a service field of the first frame.

6. The method of claim 1, wherein the setting the first frame comprises adding the information regarding the power level required for transmitting data from the first wireless network, the priority level and the notice of link adaptation to the first frame.

7. The method of claim 1, wherein in the setting the first frame, a medium access control layer of the first device composes information regarding a power, a priority level and a notice of link adaptation as a vector and sends the vector to a physical layer convergence procedure layer of the first device.

8. The method of claim 1, further comprising changing a channel to transmit data in the first network if transmission of data at the power level specified in the second frame is not allowed according to information included in the second frame.

9. The method of claim 1, wherein the second frame comprises an identifier of the second network.

10. The method of claim 1, wherein the second frame includes information indicating whether the second network is an infrastructure construction or an independent construction.

11. The method of claim 1, wherein the second frame includes a medium access control address of the second device.

12. A method of conducting a link adaptation without collision in a wireless network, the method comprising:
receiving, by a second device of a second wireless network, a first frame to notify of a link adaptation from a first device of a first wireless network;
extracting information regarding a priority level involved in data transmission in the first wireless network, from the first frame; and
sending a second frame to allow the link adaptation by the first wireless network if the priority level is higher than that of the second wireless network.

13. The method of claim 12, wherein the first and second wireless networks are based on IEEE 802.11 or IEEE 802.15.

14. The method of claim 12, wherein the priority level information represents a kind of data sent and received within first the wireless network.

15. The method of claim 12, wherein the priority level information represents a higher necessity for transmission without interruption when transmitting data within the first wireless network.

16. The method of claim 12, wherein the first frame includes a reserved bit which is agreed upon in advance, and a service field which comprises information regarding a power level required for transmitting data from the first wireless network, a priority level and a notice of link adaptation.

17. The method of claim 12, wherein the first frame includes information regarding a power level required for transmitting data from the first wireless network, the priority level and a notice of link adaptation.

18. The method of claim 12, wherein the extracting the information comprises:
extracting the priority level from the first frame at a physical layer convergence procedure (PLCP) layer of the second device; and
composing information regarding the priority level and a notice of link adaptation as a vector and sending the vector to a medium access control layer of the second device from the PLCP layer of the second device.

19. The method of claim 12, wherein the sending the second frame comprises sending the second frame if it is determined that the second network is authorized to send the second frame to the first device.

20. The method of claim 12, wherein the second frame includes an identifier of the second network.

21. The method of claim 12, wherein the second frame includes information indicating whether the second network is an infrastructure construction or an independent construction.

22. The method of claim 12, wherein the second frame includes an MAC address of the second device.

23. The method of claim 12, further comprising decreasing the transmission power or the channel when data is transmitted to and received by the second network after having sent the second frame.

24. A storage medium to record a computer readable program to perform a method for conducting a link adaptation without collision in a wireless network, the method comprising:
setting a first frame, by a first device of a first wireless network, by setting information regarding a power level required for transmitting data from the first wireless network, a priority level, and a notice of link adaptation in the first frame;
sending the first frame wirelessly;
receiving a second frame including a response to the first frame from a second device of a second wireless network having received the first frame; and
sending data at a power level that is specified in the second frame if transmission of data with the power level specified in the second frame is permitted.

25. A storage medium to record a computer readable program to perform a method of conducting a link adaptation without collision in a wireless network, the method comprising:
receiving, by a second device of a second wireless network, a first frame to notify of a link adaptation from a first device of a first wireless network;
extracting information regarding a priority level involved in data transmission in the first wireless network, from the first frame; and
sending a second frame to allow the link adaptation by the first wireless network if the priority level is higher than that of the second wireless network.
